(19) United States
(12) Patent Application Publication
(10) Pub. No.: US 2011/0151281 A1
(43) Pub. Date: Jun. 23, 2011

(54) MAGNETIC RECORDING MEDIA

(75) Inventor: Tetsutaro INOUE, Osaka (JP)

(73) Assignee: Hitachi Maxell, Ltd., Ibaraki-shi (JP)

(21) Appl. No.: 12/642,619

(22) Filed: Dec. 18, 2009

(51) Int. Cl. G11B 5/706

(52) U.S. Cl. 428/846

(57) ABSTRACT

A magnetic recording medium which has a non-magnetic substrate and a magnetic layer formed on the non-magnetic substrate, in which the magnetic layer contains magnetic powder with a particle size of 40 nm or less and a binder, an autocovariance length Ma of the magnetic layer in its lengthwise direction is 70 nm or less, an autocovariance length Mb of the magnetic layer in its widthwise direction is 80 nm or less, and a ratio Ma/Mb is from 0.80 to 1.20.

### FIELD OF THE INVENTION

The present invention relates to a coating type magnetic recording medium having high density recording characteristics. In particular, it relates to a magnetic recording medium which can reduce medium noise when used with a high density recording system.

### BACKGROUND ART

A coating type magnetic recording medium comprising a magnetic layer containing magnetic powder dispersed in a binder is required to have a further increased recording density, with the transition of recording/reproducing systems from an analog form to a digital form. Such a requirement increases year after year particularly in the field of magnetic recording media used as high density digital video tapes and backup tapes for computers.

To meet such a requirement for a higher recording density, the particle size of magnetic powder is made smaller and smaller in these years. At present, metallic magnetic powder comprising acicular magnetic particles with a particle size of about 100 nm is in practical use. In addition, the coercive force and saturation magnetization of magnetic powder have been improved year by year, and presently, metallic iron magnetic powder having a coercive force of 199.0 kA/m or more and a saturation magnetization of 120 Am²/kg or more has been realized by using an iron-cobalt alloy (cf. JP-A-03-049026). For the purpose of improving an output of data recorded with a short wavelength, it is proposed to disperse magnetic powder up to almost primary particles during the preparation of a magnetic coating composition so as to increase the packing density of the magnetic powder in a magnetic layer (cf. JP-A-2002-352412).

By making effective use of the dispersion technology and the magnetic powder comprising such fine magnetic particles as described above, a computer backup tape “LTO Ultrium®” with which the shortest recording wavelength is used at present achieves the following magnetic characteristics: a coercive force being about 210 kA/m; a product (Br·δ) of the residual magnetic flux density Br and the thickness δ of the magnetic layer being about 28 nTm; and the gradation being about 0.9.

### SUMMARY OF THE INVENTION

In a recording system for a computer, it has been considered to replace a conventional induction head used as a magnetic head for reproducing recorded data with a magneto-resistance effect type magnetic head such as a magneto-resistance effect type magnetic head (a MR head), an anisotropic magneto-resistance effect type magnetic head (an AMR head), a giant magneto-resistance effect type magnetic head (a GMR head) and a tunnel magneto-resistance effect type magnetic head (a TMR head), which are hereinafter collectively referred to as MR type heads. In a system employing such a MR type head, noises attributed to the system can be significantly reduced, and therefore noises attributed to a magnetic recording medium dominantly affect the S/N ratios of the system. Consequently, it is necessary to reduce noises from a recording medium in order to improve the S/N ratio of the system for achieving higher density recording performance in future.

To increase the recording density of a magnetic recording medium used as a backup tape for a computer, the magnetic recording medium is required to have a higher linear recording density by the decrease of a recording wavelength and also to have a higher track density by the decrease of the width of a track. However, with the increase of a linear recording density and a track density, magnetically recorded data adjacent to each other are more likely to interfere with each other to increase noises.

In order to achieve a still higher linear recording density and track density, the present invention is intended to provide a magnetic recording medium which will serve as a polestar for reducing medium noise.

The present inventors have achieved the foregoing object based on the following finding: the present inventors paid their attentions to the agglomeration of magnetic particles in the magnetic layer of a magnetic recording medium with a high linear recording density and a high track density for use with a high density recording system, and they found that noise from the medium is remarkably reduced by suppressing the agglomeration of the magnetic particles and controlling the agglomeration of the magnetic particles so as to be isotropic in the lengthwise direction and the widthwise direction.

That is, the present invention provides a magnetic recording medium which comprises a non-magnetic substrate and a magnetic layer formed on the non-magnetic substrate, wherein the magnetic layer contains magnetic powder with a particle size of 40 nm or less and a binder, an autocovariance length Ma of the magnetic layer in its lengthwise direction is 70 nm or less, and an autocovariance length Mb of the magnetic layer in its widthwise direction is 80 nm or less, and a ratio of the autocovariance length Ma to the autocovariance length Mb (Ma/Mb) is from 0.80 to 1.20.

According to this magnetic recording medium, the noise attributed to the particles can be reduced by the use of the magnetic powder comprising fine magnetic particles with a particle size of 40 nm or less. The autocovariance length Ma of the magnetic layer in the lengthwise direction is 70 nm or less, and therefore, the agglomeration of the magnetic particles in this direction is suppressed, so that a magnetization transition region in this direction can be decreased. In addition, the autocovariance length Mb of the magnetic layer in the widthwise direction is 80 nm or less, and therefore, the agglomeration of the magnetic particles in this direction is suppressed, so that the tolerance to off-track increases to narrower the width of a track. Furthermore, the ratio of the autocovariance length Ma to the autocovariance length Mb (Ma/Mb) is 0.80 to 1.20 and thus the autocovariance length Ma and the autocovariance length Mb are isotropic, so that a bit aspect ratio can be decreased.

Preferably, the magnetic layer contains iron nitride magnetic powder as magnetic powder. Since the iron nitride magnetic powder is particulate magnetic powder, the agglomeration of the magnetic particles in both of the lengthwise direction and the widthwise direction is further suppressed, and thus, the magnetic layer formed can have the autocovariance length Ma and the autocovariance length Mb which are more isotropic.

The present invention can provide a magnetic recording medium with a higher linear recording density and a higher track density, which is reduced in medium noise and is suitable for use with a high density recording system.

### BRIEF DESCRIPTION OF THE DRAWINGS

FIG. 1 is a photograph of the magnetic tape of Example 1 according to the present invention, showing the image of a leakage magnetic field from the magnetic tape;

FIG. 2 is a photograph showing the magnetic correlation of the image of the leakage magnetic field of FIG. 1;

FIG. 3 is a photograph showing the image of the leakage magnetic field from a conventional high density magnetic recording tape; and

FIG. 4 is a photograph illustrating the magnetic correlation of the image of the leakage magnetic field of FIG. 3.

### DETAILED DESCRIPTION OF THE INVENTION

In the case of a coating type high density magnetic recording medium, fine magnetic powder is used and highly dispersed to suppress medium noise and to achieve a higher recording density. For example, the above-described computer backup tape LTO Ultrium® achieves a linear recording density of 314 kbpi (shortest recording wavelength: 0.15 μm) and a track density of 5,080 tpi (reading track width: 5 μm). To correspond a still higher recording density, the recording wavelength and the tracks of the recording medium should be further decreased. When the bit interval is decreased to increase the linear recording density, the magnetized particles are opposed to one another centering on the magnetization reversal in the magnetic layer and, therefore, a large internal magnetic field called a diamagnetic field is induced around this magnetization reversal towards the decrease of magnetization. Due to this diamagnetic field, a transition region with a finite width, i.e., a magnetization transition region in which the magnetization has not yet reached a sufficient value, is formed in the magnetization reversal area. Accordingly, magnetization transition regions adjacent to each other are more likely to interfere with each other during the recording of data with a short wavelength, and a magnetization transition region on the boundary of the adjacent regions becomes a source of noises. When the track density is increased, magnetically recorded data across the tracks adjacent to each other interfere with each other, and a magnetization transition region across the tracks is likely to become a source of noises. In the above-described high density recording, the shape of recording bits seems to be a factor having a significant influence on the noise. In other words, when the agglomeration degree of magnetic particles in an agglomeration is less uniform, even if the magnetization transition regions in the lengthwise and widthwise directions are small, the shapes of recording bits tend to become anisotropic, resulting in the deterioration of the bit aspect ratio. For this reason, a balance between the high linear recording density and the high track density is disrupted to induce noise.

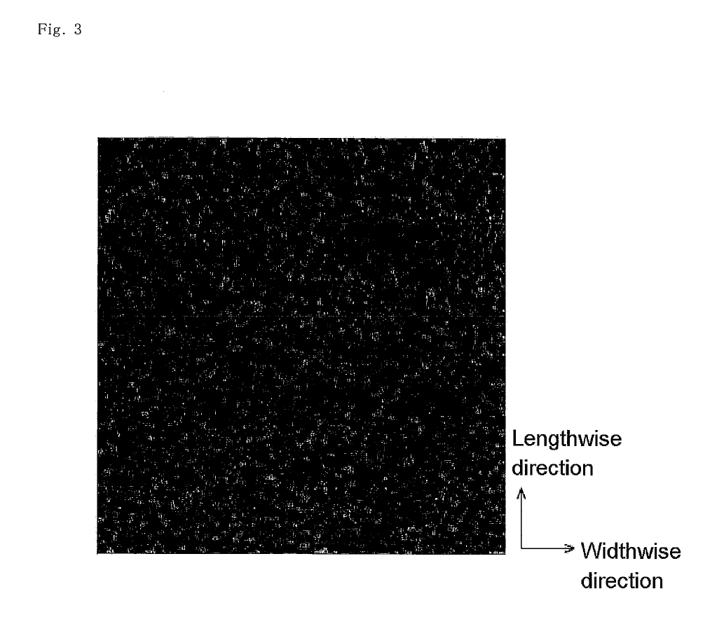

FIG. 3 shows the leakage magnetic field of the magnetic layer of MAXELL LTO4 (trade name) for LTO Ultrium®, which was observed with a magnetic force microscope (or MFM). The conditions for measuring the leakage magnetic field may be the same as those for measuring the leakage magnetic field of a conventional coating type magnetic recording medium using a magnetic force microscope, that is, a scanning region of from 0.5 to 40 μm square; a scanning speed of from 0.25 to 20 μm/sec; and a resolution of from 12 to 1,024 points/μm. In the photograph of FIG. 3, the portions seen black are the agglomerations of magnetic particles, i.e., magnetic clusters. The magnetic clusters are known to affect the medium noise, and it is studied to reduce the size of magnetic clusters by highly dispersing the magnetic particles. However, the magnetic cluster size is a scalar value and can be observed by measuring a difference between magnetic forces received from the magnetic layer, with the result that only the size of the agglomeration of the magnetic particles can be observed. Therefore, the degree of agglomeration of the magnetic particles in the agglomerate cannot be evaluated. In other words, although it is effective to suppress the agglomeration of the magnetic particles and to reduce the size of the magnetic cluster in order to reduce medium noise, the bit aspect ratio collapses to increase the medium noise, when the agglomerating state of the magnetic particles is anisotropic, such that the state varies in the lengthwise or widthwise direction.

As a means for observing the agglomeration degree of a magnetic material, an autocovariance coefficient is used for a thin magnetic film for a hard disc or the like. The calculation of the autocovariance coefficient makes it possible to know how the agglomeration of magnetic materials at a certain measuring point resembles other agglomerations of magnetic materials adjacent thereto. It is therefore considered that a coating type magnetic recording medium will have an isotropic autocovariance coefficient, if magnetic particles are uniformly dispersed up to primary particles in the magnetic layer thereof.

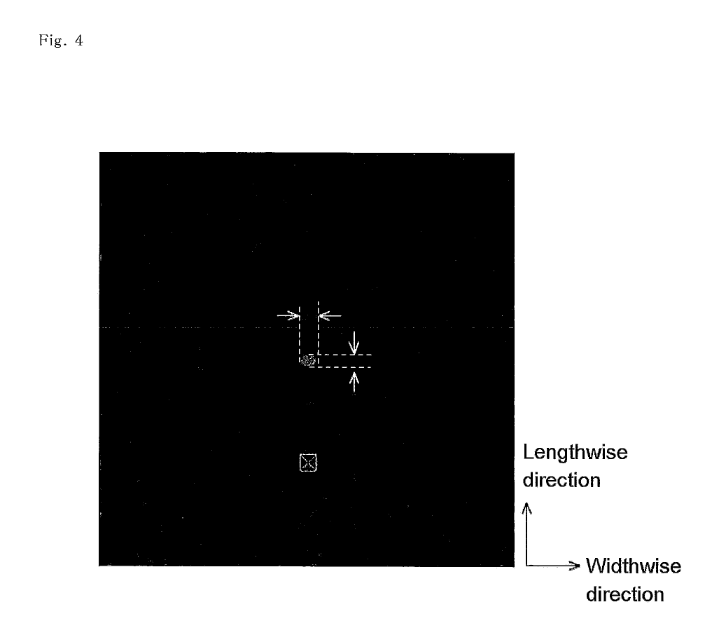

FIG. 4 shows the magnetic correlation diagram of the leakage magnetic field image shown in FIG. 3. In this magnetic correlation diagram, the magnetization intensity data of a two-dimensional magnetic image obtained with the above-described magnetic force microscope is shifted by optional distances in the lengthwise direction (direction X) and the widthwise direction (direction Y); the magnetic force data before the shift and the magnetic force data after the shift are accumulated; the result of the accumulation is added to the value of the magnetic force data before the shift over the entire measured region; and the resultant value is defined as the autocovariance coefficient after the shift. Accordingly, the autocovariance coefficient is the largest when the magnetization intensity data is not shifted (X=0 and Y=0). The autocovariance lengths are determined by measuring the respective distances of the shift in the directions X and Y, when an autocovariance coefficient is 1% of the autocovariance coefficient found before the shift.

The elliptic portion at the center of the diagram has an autocovariance coefficient which is 1% of the autocovariance coefficient found before the shift. In such a portion, the magnetic particles are present with being analogously agglomerated from the center of the ellipse. In this elliptic portion, the autocovariance length of the magnetic layer in the lengthwise direction is 75 nm; and that in the widthwise direction is 120 nm, so that the ratio of the former to the latter is 0.63. Thus, the magnetic layer has a correlation spread in the widthwise direction rather than the lengthwise direction as shown in FIG. 4. Therefore, in this magnetic recording medium, the autocovariance coefficient in the lengthwise direction and the widthwise direction collapses, even if the autocovariance length in the lengthwise direction or the widthwise direction is small, so that the bit aspect ratio is supposed to increase. Therefore, it may be considered that the noise from the magnetic recording medium will increase when the recording density of the medium will be further increased.

From the results of the above-described magnetic correlation diagram, it is recognized that the shape of the magnetic particles and the autocovariance coefficient has the following relationship. That is, in the case of the coating type magnetic recording medium such as a magnetic tape, acicular magnetic particles are used and are oriented in the lengthwise direction in a magnetic field, so that the correlation length in the lengthwise direction may be larger than that in the widthwise direction. In other words, the agglomeration degree of the magnetic particles is more analogous in the lengthwise direction than that in the widthwise direction. However, as shown in the diagram, the autocovariance length in the widthwise direction is larger than that in the lengthwise direction. On the other hand, in the case of a magnetic recording medium comprising hexagonal barium ferrite magnetic particles, i.e., plate-like magnetic particles, the autocovariance length in the lengthwise direction is confirmed to be larger than that in the widthwise direction, in contrast to the magnetic medium using the acicular magnetic particles. Accordingly, it can be understood that the autocovariance coefficient indicating the agglomeration degree of the magnetic particles has a relationship contrary to the autocovariance coefficient expected from the shape of the magnetic particles.

The autocovariance lengths of a magnetic layer capable of reducing the medium noise, in the lengthwise direction and the widthwise direction, and a relationship therebetween are examined from the above-described viewpoints. As a result, it is confirmed that tne formation of the following magnetic layer makes it possible to provide a magnetic recording medium causing the reduced medium noise, even when the linear recording density and the track density of the recording medium are further increased: that is, such a magnetic layer has an autocovariance length Ma of 70 nm or less in the lengthwise direction and an autocovariance length Mb of 80 nm or less in the widthwise direction, so that the ratio Ma/Mb of the autocovariance lengths is from 0.80 to 1.20. That is, when the autocovariance length Ma is 70 nm or less, preferably 10 nm or more and 70 nm or less, and when the autocovariance length Mb is 80 nm or less, preferably 10 nm or more and 60 nm or less, the magnetization transition region in each direction can be narrowed. When the ratio Ma/Mb is 0.80 or more and 1.20 or less, preferably 0.80 or more and 1.05 or less, it is possible to form isotropic recording bits and to achieve a high linear recording density and high track density in good balance. For example, the above-described magnetic recording medium can be far reduced in medium noise than any of the conventional magnetic recording media, even if its linear recording density is as high as 330 kbpi or more, and its track density is as high as 10 ktpi or more. Hitherto, there has never been proposed any magnetic recording medium reduced in medium noise by specifying the autocovariance lengths of its magnetic layer in the lengthwise and widthwise directions and the ratio thereof with using, as the indexes, the sizes and degrees of the agglomerations of the magnetic particles in the magnetic layer.

In the present invention, in order to produce a magnetic layer having small autocovariance lengths Ma and Mb in the lengthwise direction and the widthwise direction and the isotropic ratio Ma/Mb of the autocovariance lengths, magnetic particles are not only highly dispersed but also are prevented from re-agglomeration as much as possible in each of the steps of coating, orienting and drying. According to the present inventors' studies, the following methods are found to be effective for forming a magnetic layer which has the above-specified autocovariance lengths in the lengthwise and widthwise directions and an isotropic relationship therebetween: that is, a method comprising applying a high shear force to fine magnetic particles to disperse them; a method comprising applying a magnetic coating composition and drying the resulting magnetic layer at a low speed; and a method comprising gradually orienting a magnetic layer. Particularly, it is preferable to employ at least two methods in combination, out of the following three methods:
(1) a preliminary dispersing method comprising the steps of preparing a first composition which contains magnetic powder, a binder and an organic solvent, and has a non-solvent content of 40% by weight or less, and preparing a second composition by mixing and stirring the first composition while applying a shear force thereto, and concentrating the second composition until the non-solvent content of the second composition reaches 80% by weight or more;
(2) a method including a constant-rate drying period during which the surface temperature of a magnetic coating composition on a non-magnetic substrate is substantially kept constant, in the step of orienting the magnetic particles in the magnetic coating composition in a predetermined direction in a magnetic field, while carrying out a drying step to remove the solvent from the magnetic coating composition applied to the non-magnetic substrate; and
(3) a method of continuously carrying out a first orientation step in a high magnetic field and a second orientation step in a low magnetic field for an orientation treatment.

Hereinafter, magnetic powder, a binder, a magnetic layer and a non-magnetic substrate which are suitable for use in a magnetic recoding medium according to the present invention, and also a production process of the magnetic recording medium will be explained.

In the present invention, fine magnetic particles with a particle size of 40 nm or less, preferably from 5 to 30 nm, are used as the magnetic powder. The use of such fine magnetic particles is effective to reduce particle noise. Specific examples of the magnetic powder include acicular metallic iron magnetic powder, plate-like hexagonal ferrite magnetic powder, particulate (spherical or ellipsoidal) iron nitride magnetic powder, etc. Among them, the metallic iron magnetic powder or the iron nitride magnetic powder is preferable because the resultant magnetic layer can readily has a higher coercive force and higher saturation magnetization. In particular, the iron nitride magnetic powder is especially preferable, because it has crystalline magnetic anisotropy and comprises substantially spherical or ellipsoidal magnetic particles and thus it has a smaller agglomerating force than the acicular or plate-like magnetic particles. Such iron nitride magnetic powder is described in, for example, JP-A-2000-277311. Here, the particle size means the length of the major axis in case of acicular magnetic particles, or the diameter in case of plate-like magnetic particles, or the radius or the major axis in case of the spherical or ellipsoidal magnetic particles. The particle size is determined by averaging the particle sizes of 100 magnetic particles selected from the photograph of magnetic particles taken with a transmission electron microscope (TEM) at 200,000-fold magnification.

As the metallic iron magnetic powder, acicular α-Fe magnetic powder and Fe—Co magnetic powder are preferable, and the Fe—Co magnetic powder is more preferable. The Fe—Co magnetic powder is produced by any of the following methods: (a) baking goethite powder to obtain magnetite powder, and thermally reducing the magnetite powder in a cobalt ion-containing aqueous solution to ion-exchange divalent Fe ions with Co ions in the same solution; (b) thermally reducing Co-containing acicular goethite powder obtained from an aqueous alkaline suspension containing an iron salt and a cobalt salt; (c) reducing a co-precipitant obtained from an iron salt and a cobalt salt added to an aqueous solution of oxalic acid; (d) thermally reducing iron oxide particles the surfaces of which are coated with cobalt; (e) adding a reducing agent to a solution containing an iron salt and a cobalt salt; (f) obtaining an alloy magnetic powder by vaporizing a metal in an inert gas, and allowing the metal to collide with the molecules of the gas; and (g) allowing the vapors of the chlorides of iron and cobalt to flow in a gaseous mixture of hydrogen, nitrogen or argon to reduce the chlorides metals. Among these methods, the methods (a) and (b) are preferably employed in combination, since a solid solution containing a large amount of Co can be obtained, and the resultant magnetic powder is superior in corrosion resistance. The Fe—Co magnetic powder can achieve a maximum saturation magnetization and a maximum coercive force, when the amount of Co in the Fe—Co magnetic powder is around 30% of the total of Fe and Co. When the amount of Co is too large, it is impossible to alloy Co with the magnetic iron metal, and excess Co forms a cobalt oxide, which is likely to deteriorate the magnetic characteristics. Therefore, the amount of Co is selected so that the weight ratio of Co to Fe is from 0.3:1 to 0.5:1. In this regard, the Fe—Co magnetic powder may contain other elements, for example, a transition metal such as Zn, Sn, Ni, Mn, Ti, Cr, Cu, Nd, La, Sm or Y, and a rare earth element. Preferably, the surfaces of the Fe—Co magnetic particles are coated with an inorganic oxide in order to prevent the sintering of the particles during the thermal reduction thereof, and in order to improve the dispersibility of the magnetic particles in a magnetic coating composition. As the inorganic oxide, aluminum oxide and silicon oxide are exemplified. Among them, the aluminum oxide is particularly preferable since it is superior in hardness and effective to improve the abrasion resistance of the magnetic particles. The coating of the magnetic particles is carried out by reacting water with an alcohol solution containing a compound comprising aluminum, silicon or the like to hydrolyze the compound to form a hydroxide of aluminum or silicon on the surfaces of iron oxide particles for coating them. The coercive force of the Fe—Co magnetic powder is preferably from 160 to 320 kA/m, more preferably from 200 to 300 kA/m, and the saturation magnetization thereof is preferably from 60 to 200 Am²/kg, more preferably from 80 to 180 Am²/kg.

Preferably, the iron nitride magnetic powder contains 1 to 20 atomic % of nitrogen based on the iron atoms. In each of the iron nitride magnetic particles, a part of iron may be substituted by other transition metal element. Specific examples of the other transition metal element include Mn, Zn, Ni, Cu, Co, etc. Among them, Co and Ni are preferable, and Co is particularly preferable, since the use of Co is the most effective to improve the saturation magnetization of the resultant magnetic layer. However, the content of Co is 10 atomic % or less based on the iron atoms. When the content of Co is too large, a time necessary for nitriding becomes longer. The iron nitride magnetic powder may optionally contain a rare earth element. Particularly preferable is iron nitride magnetic powder in which each magnetic particle has a double layer structure comprising an inner layer portion containing an iron nitride having a Fe₁₆N₂ phase as a main phase, and an outer layer portion mainly containing a rare earth element. Such iron nitride magnetic powder has better dispersibility and shape maintenance, despite its higher coercive force. Examples of such a rare earth element include Y, Yb, Ce, Sm, Pr, La, Eu and Nd. Among them, Y, Sm and Nb are preferable because the use thereof is effective to retain the shapes of magnetic particles during the reduction of the magnetic particles. The content of the rare earth element is preferably from 0.05 to 20 atomic %, more preferably from 0.1 to 15 atomic %, most preferably from 0.5 to 10 atomic %, based on the iron atoms. When the amount of the rare earth element is too small, the dispersibility is not effectively improved and also the particle shape-maintenance effect is less attained during the reduction of the particles. When the amount of the rare earth element is too large, the amount of the unreacted rare earth elements increases and the dispersion of the particles and the application of the coating composition are degraded, and further the coercive force or the saturation magnetization may be excessively decreased. Furthermore, the iron nitride magnetic powder may contain B, Si, Al and P. The addition of such elements is effective to produce highly dispersible iron nitride magnetic powder. These elements are less expensive than the rare earth elements and thus are cost-effective. The total content of such elements, i.e., B, Si, Al and P, is preferably from 0.1 to 20 atomic % based on the iron atoms. When the content of these elements is too small, the shape maintenance effect of the magnetic particles is poor. When the content of these elements is too large, the saturation magnetization of the magnetic particles tends to decrease. Optionally, the iron nitride magnetic powder may further contain C, Ca, Mg, Zr, Ba, Sr, etc. The addition of these elements in combination with the rare earth element is effective to impart a higher shape maintenance effect and higher dispersibility to the magnetic particles.

The production method of the iron nitride magnetic powder is not limited. For example, the production method described in JP-A-2004-273094 may be employed. Specifically, an iron oxide or an iron hydroxide is used as a starting material. Examples of the iron oxide and the iron hydroxide include hematite, magnetite, goethite, etc. The particle size of the starting material, although not limited, is preferably from 5 to 80 nm, more preferably from 5 to 50 nm, still more preferably from 5 to 30 nm. The magnetic particles having a too small particle size are likely to be sintered during the reduction thereof. The magnetic particles having a too large particle size are likely to be less homogeneously reduced, and thus, the control of the particle size and magnetic characteristics of the resultant iron nitride magnetic powder is difficult.

The particles of the iron oxide or hydroxide as the starting material may be coated with any of the above-described rare earth elements. For example, this coating treatment is carried out by dispersing the starting material in an aqueous solution of an alkali or an acid, dissolving a salt of a rare earth element in this dispersion, neutralizing the dispersion to precipitate and deposit a hydroxide or hydrate containing the rare earth element on the particles of the starting material. The particles of the starting material may be coated with an element such as B, Si, Al, P and the like. The coating treatment using these elements is carried out, for example, by preparing a solution of a compound containing these elements, and immersing the starting material in this solution to coat the starting material with B, Si, Al, P and the like. To efficiently carry out this coating treatment, an additive such as a reducing agent, a pH buffer, a particle size-controlling agent, etc. may be further added to the solution. Furthermore, in the coating treatment, the rare earth element and the element such as B, Si, Al, P and the like may be concurrently or alternatively coated on the starting material.

Next, the starting material is thermally reduced in a stream of a reducing gas. The reducing gas, while not limited, may be a hydrogen gas, a carbon monoxide gas or the like. The reducing temperature is preferably from 300 to 600° C. When the reducing temperature is lower than 300° C., the reduction reaction does not sufficiently proceed. When the reducing temperature is higher than 600° C., the particles of the starting material tend to be sintered.

After the thermal reduction, the resulting particles are subjected to a nitriding treatment to obtain the iron nitride magnetic particles containing iron and nitrogen as constituting elements. Preferably, the nitriding treatment is carried out using an ammonia-containing gas. The nitriding treatment may be carried out using a gas mixture of the ammonia gas with a carrier gas such as a hydrogen gas, a helium gas, a nitrogen gas or an argon gas, besides the ammonia gas alone. The nitrogen gas is particularly preferable because of its low cost. The temperature for the nitriding treatment is preferably from 100 to 300° C. When the nitriding temperature is too low, the nitriding reaction does not sufficiently proceed, and thus the coercive force-improving effect is low. When the nitriding temperature is too high, the nitriding reaction excessively proceeds to increase the proportion of the Fe₄N phase or the Fe₃N phase, resulting in that the coercive force tends to decrease, and the saturation magnetization excessively decreases. The conditions for the nitriding treatment are selected so that the content of nitrogen can be from 1 to 20 atomic % based on the iron atoms. When the content of nitrogen is too small, the proportion of the Fe₁₆N₂ phase decreases, and thus, the coercive force-improving effect deteriorates. When the content of nitrogen is too large, the Fe₄N phase or the Fe₃N phase is more likely to form, and the coercive force tends to decrease and the saturation magnetization excessively decreases. The coercive force of the iron nitride magnetic powder described above is preferably from 160 to 320 kA/m, more preferably from 200 to 300 kA/m. The saturation magnetization thereof is preferably from 60 to 200 Am²/k_{g}, more preferably from 80 to 180 Am²/kg.

As the hexagonal ferrite magnetic powder, hexagonal barium ferrite magnetic powder is preferably used. The hexagonal ferrite magnetic powder may contain, in addition to the essential constituting elements, elements such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, B, Ge and Nb. The hexagonal ferrite magnetic powder may be produced by any of the conventional methods. For example, the glass crystallization method is employed, in which method, barium oxide, iron oxide and a metal oxide which substitutes iron, and boron oxide as a glass-forming material are mixed to attain a desired ferrite composition, and the mixture is then molten and quenched to obtain an amorphous material, which is then re-heated, followed by washing and grinding to obtain barium ferrite crystalline particles. The coercive force of the hexagonal ferrite magnetic powder is preferably from 120 to 320 kA/m, and the saturation magnetization thereof is preferably from 40 to 60 Am²/kg.

As the binder, at least one resin selected from the group consisting of vinyl chloride resins, nitrocellulose resins, epoxy resins and polyurethane resins is used. Specific examples of the vinyl chloride resins include a vinyl chloride resin, vinyl chloride-vinyl acetate copolymer resin, vinyl chloride-vinyl alcohol copolymer resin, vinyl chloride-vinyl acetate-vinyl alcohol copolymer resin, vinyl chloride-vinyl acetate-maleic anhydride copolymer resin, vinyl chloride-hydroxyl group-containing alkyl acrylate copolymer resin, etc. Among those, the combination of a vinyl chloride resin and a polyurethane resin is preferable, and the combination of a vinyl chloride-hydroxyl-containing alkyl acrylate copolymer resin and a polyurethane resin is more preferable. Preferably, any of these binders contains a functional group so as to improve the dispersibility of the magnetic powder and to increase the packing proportion of the magnetic powder. Specific examples of such a functional group include COOM, SO₃M, OSO₃M, P═O(OM)₃, O—P═O(OM)₂, wherein M is a hydrogen atom, an alkali metal salt or an amine salt, OH, NR¹R², NR³R⁴R⁵, wherein each of R¹, R², R³, R⁴ and R⁵ is a hydrogen atom or a hydrocarbon group usually having 1 to 10 carbon atoms, an epoxy group, etc. When two or more resins are used in combination as the binders, preferably, the resins have the same polarity. In particular, the combination of the resins having —SO₃M groups is preferably use. The binder is used in an amount of from 7 to 50 parts by weight, preferably from 10 to 35 parts by weight, per 100 parts by weight of the magnetic powder. The combination of 5 to 30 parts by weight of a vinyl chloride resin and 2 to 20 parts by weight of a polyurethane resin is particularly preferable.

Preferably, the binder is used in combination with a thermocurable crosslinking agent which is bonded to the functional group of the binder to form a crosslinked structure. Specific examples of the crosslinking agent include isocyanate compounds such as tolylene diisocyanate, hexamethylene diisocyanate and isophorone diisocyanate; reaction products of the isocyanate compounds with compounds each having a plurality of hydroxyl groups, such as trimethylolpropane; and a variety of polyisocyanates such as condensation products of the isocyanate compounds. The crosslinking agent is usually used in an amount of from 10 to 50 parts by weight per 100 parts by weight of the binder.

In the present invention, the thickness of the magnetic layer is preferably 200 nm or less, more preferably from 10 to 200 nm, still more preferably from 10 to 100 nm, to suppress the decrease of output due to demagnetization, which is the essential problem of the lengthwise recording on the magnetic tape. When the thickness of the magnetic layer exceeds 200 nm, reproduction output tends to decrease due to thickness loss, or the product of the residual magnetic flux density and the thickness of the magnetic layer becomes too large, resulting in that the distortion of a reproduction output due to the magnetic saturation of the MR type head tends to appear. When the thickness of the magnetic layer is less than 10 nm, the magnetic layer may not have a uniform thickness.

In case of a magnetic tape, the coercive force of the magnetic layer in the lengthwise direction is preferably from 79.6 to 318.4 kA/m, more preferably from 119.4 to 318.4 kA/m. When the coercive force is smaller than 79.6 kA/m, the output is likely to be decreased by diamagnetic demagnetization during the recording of data with a short wavelength. When the coercive force exceeds 318.4 kA/m, it becomes difficult to record data with the magnetic head. The squareness ratio (Br/Bm) in the lengthwise direction of the magnetic layer is usually from 0.6 to 0.9, preferably from 0.8 to 0.9. The product of the saturation magnetic flux density in the lengthwise direction and the thickness of the magnetic layer is preferably from 0.001 to 0.1 μTm, more preferably from 0.0015 to 0.05 μTm. When this product is smaller than 0.001 μTm, a reproduction output tends to decrease, even when a MR type head is used. When this product exceeds 0.1 μTm, it becomes difficult to attain a high output within a short wavelength region.

In the present invention, the magnetic layer may contain additives such as carbon black, a lubricant and non-magnetic powder in order to improve its characteristics such as electric conductivity, surface smoothness and durability. As the carbon black, for example, acetylene black, furnace black or thermal black may be used. The content of the carbon black is preferably from 0.2 to 5 parts by weight per 100 parts by weight of the magnetic powder. As the lubricant, specifically, a fatty acid, a fatty ester or a fatty amide, each having 10 to 30 carbon atoms, may be used. The content of the lubricant is preferably from 0.2 to 3 parts by weight per 100 parts by weight of the magnetic powder. As the non-magnetic powder, specifically, alumina powder, silica powder or the like may be used. The content of the non-magnetic powder is preferably from 1 to 20 parts by weight per 100 parts by weight of the magnetic powder.

Prior to the preparation of a magnetic coating composition, preferably, a preliminary dispersion treatment is carried out as follows: a first composition is prepared, which composition contains the magnetic powder, binder and organic solvent, and optionally, other additives, and has a non-solvent content of 40% by weight or less, preferably from 1% by weight to 30% by weight; a second composition is prepared by mixing and stirring the first composition while applying a shear force thereto; and the second composition is concentrated until the non-solvent content reaches 80% by weight or more, preferably 90% by weight or more. The highly concentrated composition prepared by such a preliminary dispersion treatment is used to prepare a magnetic coating composition comprising fine magnetic particles highly dispersed therein. Examples of the organic solvent include ketone solvents such as methyl ethyl ketone, cyclohexanone and methyl isobutyl ketone; ether solvents such as tetrahydrofuran and dioxane; ester solvents such as ethyl acetate and butyl acetate; and glycol solvents such as ethylene glycol, propylene glycol, ethylene glycol monoethylether and propylene glycol monomethylether. These organic solvents may be used alone, or some of them may be used as a mixture. The organic solvent above may be used together with an aromatic organic solvent such as toluene.

Examples of a mixer or a stirrer used in the preparation of the second composition include a rotary shear type stirrer in which a shaft having rotor blades mounted thereon is rotated at a high speed in a dispersing container; an attritor and a sand mill in which a shaft having rotor blades mounted thereon is rotated at a high speed in a dispersing container including dispersing media; an ultrasonic dispersing machine; and a high-pressure spray collision type dispersing machine.

In the preparation of the second composition, a shear force is preferably as high as possible, and a shear force is applied so that the shear rate can be 10⁴/sec. or higher, preferably 10⁵/sec. or higher. To apply such a high shear force, there is used a stirrer rotatable at a high speed, which comprises rotor blades and a stationary member disposed with a small clearance therebetween. Examples of such a stirrer include batch type stirrers such as ULTRA-TURRAX (IKA Works), T.K. Homomixer (PRIMIX Corporation), T.K. Filmix (PRIMIX Corporation) and Clear Mix (Mtechnique), and continuous type stirrers such as Ebara Milder (Ebara Corporation) and CAVITRON (EUROTEC). In case where a continuous type stirrer is used, the treatment may be carried out once, or may be carried out two or more times by setting up a circulation line.

To concentrate the second composition thus prepared to obtain a composition containing 80% by weight or more of the non-solvent component, the organic solvent is evaporated from the second composition by heating or depressurization.

The magnetic coating composition is prepared by kneading and dispersing the composition prepared by the above-described preliminary dispersion treatment. To knead and disperse the composition, any of the kneading and dispersing methods used for the conventional coating type magnetic recording media may be employed. To knead the composition, a batch type kneader or a continuous type twin-screw kneader may be used. To disperse the composition, a media type disperser may be used. As the media type disperser, there may be used any of the conventional dispersers such as a disperser comprising a stirring shaft provided with discs (perforated, notched or grooved), pins or rings, a rotor rotation type disperser (e.g., Nano Mill, Pico Mill, Sand Mill or Daino Mill), etc. The dispersing time is preferably from 30 to 90 minutes in terms of a residence time, while it varies depending on the components of the magnetic coating composition and the usage thereof.

The magnetic recording medium of the present invention is produced by applying the magnetic coating composition prepared as above onto a non-magnetic substrate, and orienting the resulting magnetic layer. As the non-magnetic substrate, any of the non-magnetic substrates used for the conventional magnetic recording media may be used. Examples of such a non-magnetic substrate are plastic films with thickness of usually from 2 to 20 μm, formed from polyesters such as polyethylene terephthalate and polyethylene naphthalate; polyolefins; cellulose triacetates; polycarbonates; polyamide; polyimide; polyamideimide; polysulfone; aramid; aromatic polyamide, etc. As a coater, any of the coaters used for the production of the conventional magnetic recording media, for example, gravure rolls, blade coater and extrusion type coater may be used.

The magnetic coating composition applied to the non-magnetic substrate is dried to remove the solvent therefrom while magnetically orienting the magnetic particles in the magnetic coating composition in a specific direction. For this treatment, preferably, the coating step includes a constant-rate drying period during which the surface temperature of the magnetic coating composition on the non-magnetic substrate is kept substantially constant. This constant-rate drying period suppresses vigorous flowing of the magnetic particles and foaming in the flowable magnetic coating composition containing the organic solvent, which is caused by the boiling of the magnetic coating composition. In addition, the constant-rate drying period in the drying treatment makes it possible to extend a period of time during which the solvent content in the magnetic coating composition decreases at a substantially constant rate. As a consequence, the number of voids formed in the magnetic coating composition in association with the removal of the organic solvent decreases. Thus, the movement of the magnetic particles during the drying and orienting treatment can be suppressed. The constant-rate drying period is preferably 0.2 sec. or longer, more preferably from 0.1 sec. to 10 sec. When the constant-rate drying period is too short, that is, the solvent-removing rate is too high, a vigorous convection current is likely to take place in the magnetic coating composition, or foaming is likely to occur, during the drying treatment. As a result, the autocovariance lengths of the magnetic layer increases, and the agglomeration of the magnetic particles is likely to be unevenly formed in the lengthwise direction or the widthwise direction.

It is possible to control the surface temperature of the magnetic layer during the constant-rate drying period by appropriately controlling the temperature and velocity of a hot air, a distance between the magnetic coating composition and a heating means, etc. so that the evaporative latent heat released from the magnetic coating composition by evaporating the solvent from the magnetic coating composition can be well balanced with an amount of heat which is applied to the magnetic coating composition from an ambient atmosphere.

In the orientation treatment conducted at the same time as or after the coating treatment, it is preferable to continuously carry out a first orientation step and a second orientation step in which the intensities of the respective magnetic fields differ from each other. Such continuous magnetic orientation treatments can suppress re-agglomeration of the magnetic particles attributed to the return orientation of the magnetic particles during the orientation treatment. To suppress such re-agglomeration, preferably, a first orienting means used in the first orientation step and a second orienting means used in the second orientation step are located as closely as possible. The intensity of the magnetic field in the first orientation step is preferably from 399 to 1,197 kA/m, and the intensity of the magnetic field in the second orientation step is preferably from 120 to 798 kA/m. When the intensity of either magnetic field is too weak, any sufficient orientation effect cannot be obtained. When the intensity of either magnetic field is too strong, the orientation effect saturates, and the surface smoothness of the magnetic layer tends to be lost because of surface roughness caused by the magnetic field. Insofar as the above-specified ranges of the magnetic fields can be ensured, each of the orienting means may comprise a plurality of permanent magnets or solenoid magnets, or both of them in combination.

In the first orienting means used in the first orientation step, preferably, permanent magnets are arranged with their same polarities opposed to each other to repel each other, because a magnetic field with a high intensity is created at a relatively low cost. In this case, solenoid magnets may be used instead. In the second orienting means used in the second orientation step, the solenoid magnets are preferable used to create a magnetic field with a relatively constant intensity and with a constant length. In this case, the solenoid magnets may be used in combination with permanent magnets. In the second orientation step, a fluctuation in the intensity of a magnetic field to which the magnetic layer is exposed is preferably 30% or less, because it is possible to more effectively suppress the return orientation of the magnetic particles which would take place during a period while the magnetic layer would be dried and fixed in the second orientation step. The fluctuation (%) in the magnetic field intensity is determined by the equation:

[(Wₘₐₓ−Wₘᵢₙ)/Wₘₐₓ]×100

wherein Wₘₐₓ is a maximum magnetic field intensity and Wₘᵢₙ is a minimum magnetic field intensity.

The magnetic recording medium of the present invention may optionally have a primer layer between the non-magnetic substrate and the magnetic layer. The thickness of the primer layer is preferably from 0.1 to 3.0 μm, more preferably from 0.15 to 2.5 μm. When the thickness of the primer layer is smaller than 0.1 μm, the durability of the magnetic tape may tend to lower. When the thickness of the primer layer exceeds 3.0 μm, the durability-improving effect to the magnetic tape may tend to saturate and also the entire thickness of the magnetic tape increases, so that the length of the magnetic tape per reel is shortened and thus the storage capacity is decreased. The primer layer may contain the following powder in order to control the viscosity of a coating composition therefor and the rigidity of the magnetic tape: non-magnetic powder such as titanium oxide, iron oxide and aluminum oxide; and magnetic powder such as γ-iron oxide, Co-γ-iron oxide, magnetite, chromium oxide, Fe—Ni alloy, Fe—Co alloy, Fe—Ni—Co alloy, barium ferrite, strontium ferrite, Mn—Zn ferrite, Ni—Zn ferrite, Ni—Cu ferrite, Cu—Zn ferrite and Mg—Zn ferrite. These powders may be used alone, or some of them may be used as a mixture. The primer layer may further contain carbon black such acetylene black, furnace black or thermal black to impart electric conductivity to the primer layer. As a binder used in the primer layer, the resins exemplified for the binder used in the magnetic layer may be used.

The magnetic recording medium of the present invention may comprise a backcoat layer on the other surface of the non-magnetic substrate having the magnetic layer on the one surface. The thickness of the backcoat layer is preferably from 0.2 to 0.8 μm, more preferably from 0.3 to 0.8, still more preferably from 0.3 to 0.6 μm. Preferably, the backcoat layer contains carbon black such as acetylene black, furnace black or thermal black. As a binder used in the backcoat layer, the resins exemplified for the binders used in the magnetic layer and the primer layer may be used. Among the binder resins, the combination of a cellulose resin and a polyurethane resin is preferably used to decrease the friction coefficient of the magnetic tape to improve the running performance thereof.

Hereinafter, the present invention will be described in more detail by making reference to the Examples, which will not limit the scope of the present invention in any way. Hereinafter, “part(s)” means “part(s) by weight”, and “%” means “% by weight”, unless otherwise specified.

### EXAMPLES

I. Preparation of Magnetic Coating Composition

Preparation of Magnetic Coating Composition (C-1)

The first composition (solid content: 30%) comprising the components indicated in Table 1 below was stirred for 60 minutes in a rotary shear type stirrer (Clear Mix manufactured by MTechnique; rotor blade size: 50 mm; gap: 2 mm; number of rotation: 2,000 rpm; shear rate: 2.6×10⁴/sec.).

TABLE 1

| Component of First Composition | Parts |
|---|---|
| Particulate iron nitride magnetic powder | 100 |
| (containing Fe₁₆N₂ phase; added elements: Al and Y) | |
| [σs: 100 Am²/kg, Hc: 278 kA/m, particle size: 17 nm, | |
| and axial ratio: 1.1 | |
| Polyester polyurethane resin | 2 |
| (—SO₃Na group contained: 1 × 10⁻⁴ eq./g | |
| Alumina powder | 10 |
| Methyl acid phosphate | 4 |
| Tetrahydrofuran | 271 |

The resultant composition was charged in a vertical vibration drier (VFD-01, manufactured by CHUO KAKOKI CO., LTD.), and was concentrated by heating at 60° C. under a reduced pressure of 20 kPa, while vibrating the vessel (vibration rate: 1,800 cpm, and amplitude: 2.2 mm). Thus, the second composition having a solid content of 90% was obtained.

Next, the components indicated in Table 2 below were added to the second composition, and the mixture was kneaded with a continuous type twin-screw kneader.

TABLE 2

| Components Added for Kneading | Parts |
|---|---|
| Vinyl chloride-hydroxypropyl acrylate copolymer | 17 |
| (—SO₃Na group contained: 0.7 × 10⁻⁴ eq./g | |
| Polyester polyurethane resin | 4 |
| (—SO₃Na group contained: 1 × 10⁻⁴ eq./g | |
| Methyl ethyl ketone | 5 |
| Cyclohexanone | 7 |
| Toluene | 5 |

Next, the kneaded composition was diluted by adding a part of the diluting components indicated in Table 3 below, in the diluting compartment of the continuous type twin-screw kneader. The remaining diluting components were further added to the composition taken out, and the mixture was stirred at a high speed to obtain a homogeneous slurry mixture.

TABLE 3

| Diluting Components | Parts |
|---|---|
| Palmitic amide | 1 |
| Butyl stearate | 1 |
| Cyclohexanone | 190 |
| Toluene | 190 |

The slurry was dispersed with a sand mill (media: 0.5φ zirconia beads; packing rate: 80% by volume; peripheral blade speed: 10 m/sec.) for a residence time of 90 minutes, and then, the components indicated in Table 4 below were added to the dispersion. The mixture was stirred and filtered, and then it was dispersed 4 times with a high pressure spray collision type disperser (Altimizer manufactured by SUGINO MACHINE LIMITED) under a pressure of 100 MPa. Thus, a magnetic coating composition (C-1) was obtained.

TABLE 4

| Added Components | Parts |
|---|---|
| Polyisocyanate | 6 |
| Methyl ethyl ketone | 2 |
| Cyclohexanone | 8 |
| Toluene | 8 |

Preparation of Magnetic Coating Composition (C-2)

A magnetic coating composition (C-2) was prepared in the same manner as in the preparation of the magnetic coating composition (C-1), except that the amount of tetrahydrofuran in the first composition was changed to 174 parts (the solid content of the first composition: 40%).

Preparation of Magnetic Coating Composition (C-3)

A magnetic coating composition (C-3) was prepared in the same manner as in the preparation of the magnetic coating composition (C-1), except that the amount of tetrahydrofuran in the first composition was changed to 464 parts (the solid content of the first composition: 20%), and the solid content of the second composition was changed to 95%.

Preparation of Magnetic Coating Composition (C-4)

A magnetic coating composition (C-4) was prepared in the same manner as in the preparation of the magnetic coating composition (C-1), except that acicular Fe—Co magnetic powder (added elements: Al and Y) [σs: 120 Am²/kg; Hc: 207 kA/m; particle size (major axis): 35 nm; and axial ratio: 5] was used as the magnetic powder.

Preparation of Magnetic Coating Composition (C-5)

A magnetic coating composition (C-5) was prepared in the same manner as in the preparation of the magnetic coating composition (C-1), except that acicular Fe—Co magnetic powder (added elements: Al and Y) [σs: 120 Am²/kg; Hc: 207 kA/m; particle size (major axis): 35 nm; and axial ratio: 5] was used as the magnetic powder; the amount of tetrahydrofuran in the first composition was changed 174 parts (the solid content of the first composition: 40%); and the solid content of the second composition was changed to 80%.

Preparation of Magnetic Coating Composition (C-6)

A magnetic coating composition (C-6) was prepared in the same manner as in the preparation of the magnetic coating composition (C-1), except that the amount of tetrahydrofuran in the first composition was changed to 142 parts (the solid content of the first composition: 45%).

Preparation of Magnetic Coating Composition (C-7)

A magnetic coating composition (C-7) was prepared in the same manner as in the preparation of the magnetic coating composition (C-1), except that the solid content of the second composition was changed to 70%.

### Preparation of Magnetic Coating Composition (C-8)

A magnetic coating composition (C-8) was prepared in the same manner as in the preparation of the magnetic coating composition (C-1), except that acicular Fe—Co magnetic powder (added elements: Al and Y) [σs: 120 Am²/kg; Hc: 207 kA/m; particle size (major axis): 35 nm; and axial ratio: 5] was used as the magnetic powder; and the amount of tetrahydrofuran in the first composition was changed 142 parts (the solid content of the first composition: 45%).

II. Preparation of Coating Composition for Primer Layer

The components of a coating composition for a primer layer indicated in Table 5 below were kneaded with a kneader, and the mixture was dispersed with a sand mill for a residence time of 60 minutes. Then, the components indicated in Table 6 below were added to the resulting dispersion, and the mixture was stirred and filtered to obtain a coating composition for a primer layer.

TABLE 5

| Components of Coating Composition for Primer Layer | Parts |
|---|---|
| Acicular iron oxide particles | 63 |
| Carbon black | 20 |
| Particulate alumina powder | 12 |
| Methyl acid phosphate | 1 |
| Vinyl chloride-hydroxypropyl acrylate copolymer | 9 |
| (—SO₃Na group contained: 0.7 × 10⁻⁴ eq./g) | |
| Polyester polyurethane resin (Tg: 40° C.; and —SO₃Na | 5 |
| group contained: 1 × 10⁻⁴ eq./g) | |
| Tetrahydrofuran | 13 |
| Cyclohexanone | 63 |
| Methyl ethyl ketone | 137 |

TABLE 6

| Added Components for Primer Layer | Parts |
|---|---|
| Polyisocyanate | 6 |
| Cyclohexanone | 9 |
| Toluene | 9 |

III. Preparation of Coating Composition for Backcoat Layer

The components of a coating composition for a backcoat layer indicated in Table 7 below were dispersed with a sand mill for a residence time of 45 minutes. Then, polyisocyanate (8.5 parts) was added to the dispersion, and the mixture was stirred and filtered to obtain a coating composition for a backcoat layer.

TABLE 7

| Components of Coating Composition for Backcoat Layer | Parts |
|---|---|
| Carbon black (average particle size: 25 nm) | 80 |
| Carbon black (average particle size: 350 nm) | 10 |
| Particulate iron oxide particles | 10 |
| Nitrocellulose | 45 |
| Polyurethane resin (—SO₃Na group contained) | 30 |
| Methyl ethyl ketone | 525 |
| Toluene | 260 |
| Cyclohexanone | 260 |

IV. Production of Magnetic Tape

Production of Magnetic Tape (T-1)

The above-described coating composition for a primer layer was applied to a polyethylene naphthalate film with a thickness of 8 μm so that the resulting primer layer had a thickness of 0.9 μm after drying and calendering. Then, the above-described magnetic coating composition (C-1) was applied to the undried primer layer at a rate of 150 m/min. with an extrusion type coater so that the resulting magnetic layer had a thickness of 0.08 μm after dried and calendered. Thus, a magnetic sheet was obtained. The conditions for drying and orienting the magnetic layer are indicated in Table 8 below. Then, the composition for a backcoat layer was applied to the other surface of the magnetic sheet having the magnetic layer formed on one surface and was then dried. The resultant magnetic sheet was planished (or calendered), using a seven-staged calender comprising metal rolls, at 100° C. under a linear pressure of 196 kN/m, and was wound around a core. The magnetic sheet wound around the core was aged at 60° C. for 48 hours. Thus, the magnetic sheet used for evaluations was obtained. After that, the magnetic sheet was cut into a tape with a width of ½inch to obtain a magnetic tape (T-1).

Production of Magnetic Tapes (T-2) to (T-16)

Magnetic tapes (T-2) to (T-16) were produced in the same manners as in the production of the magnetic tape (T-1), except that the conditions were changed as shown in Table 8 below.

The autocovariance lengths and noises of the respective magnetic tapes produced as above were measured by the methods described below.

Autocovariance Length:

As a magnetic force microscope, NanoScope III (manufactured by Veeco) was used; and as a measuring probe, a commercially available cantilever having a cobalt alloy coating (D-MESP; beam length: 220 nm; curvature radius of tip end: 25 to 40 nm; coercive force: about 400 Ge; and magnetic moment: about 1×10⁻¹³ emu) was used. The leakage magnetic field image of a magnetic layer was measured by a frequency detection method. A scanning region was 5 μm-square; a scanning speed was 5 μm/sec; and a lift height was 20 nm.

Based on the magnetization intensity data of the obtained two-dimensional leakage magnetic field image, the magnetization intensity data was shifted by given distances in the lengthwise direction (direction X) and the widthwise direction (direction Y) within the measuring region; and this found magnetization intensity data was accumulated with the original magnetization intensity data of the leakage magnetic field image; and the results of this accumulation over the entire region where the data were duplicated were added; and this sum was defined as an autocovariance coefficient relative to the position shifted. The distances shifted in directions X and Y at which the autocovariance coefficient was found to be 1% of the autocovariance coefficient before the shift were defined as autocovariance lengths.

Noises:

A drum tester equipped with an electromagnetic induction head (track width: 25 μm, and gap: 0.1 μm) and a MR head (gap length: 8 μm) was used to evaluate noises from a magnetic tape. Both heads were set at different positions relative to the rotary drum and were operated vertically to match respective tracking. A magnetic tape with a length of about 60 cm as a test sample was wound around the rotary drum of the drum tester, and a signal with a rectangular waveform and a wavelength of 0.1 μm was recorded on the magnetic tape using a MR head. An output from the MR head was amplified with a pre-amplifier and was then read with a spectrum analyzer (linear recording density: 350 kbpi, and track density: 11 ktpi). A noise value (dB) was determined as follows: the output and the system noises were subtracted from a component of the spectrum equivalent to a wavelength component longer than 0.1 μm which was the read recording wavelength, and such differences were accumulated, and this integration value was used as a noise value (dB). This noise value was evaluated as a relative value to a noise value (0 dB) found from MAXELL LTO4 in the same manner.

The results are shown in Table 8.

TABLE 8

| Magnetic tape | | T-1 | T-2 | T-3 | T-4 | T-5 | T-6 | T-7 | T-8 |
|---|---|---|---|---|---|---|---|---|---|
| Magnetic | Type | C-1 | C-2 | C-3 | C-4 | C-5 | C-1 | C-1 | C-6 |
| coating | Magnetic powder | Iron | ← | ← | Fe—Co | ← | Iron | ← | ← |
| composition | | nitride | | | | | nitride | | |
| | Concentration (%) of first | 30 | 40 | 20 | 30 | 40 | 30 | 30 | 45 |
| | composition | | | | | | | | |
| | Concentration (%) of second | 90 | 90 | 95 | 90 | 80 | 90 | 90 | 90 |
| | composition | | | | | | | | |
| Drying | Constant-rate drying period | 5 | 5 | 5 | 5 | 5 | 0.1 | 5 | 0.1 |
| treatment | (sec.) | | | | | | | | |
| Orienting | First orientation (kA/m) | 558 | 558 | 558 | 558 | 558 | 558 | 399 | 558 |
| treatment | Second orientation (kA/m) | 239 | 239 | 239 | 239 | 239 | 239 | 399 | 239 |
| | Positions of first and second | Contin- | Contin- | Contin- | Contin- | Contin- | Contin- | Contin- | Contin- |
| | orienting magnets | uous | uous | uous | uous | uous | uous | uous | uous |
| | Fluctuation of second | 30 | 30 | 30 | 30 | 30 | 30 | 70 | 30 |
| | orientation magnetic field (%) | | | | | | | | |
| Autocovariance | Lengthwise direction Ma (nm) | 42 | 44 | 39 | 46 | 48 | 41 | 41 | 63 |
| length | Widthwise direction Mb (nm) | 44 | 46 | 40 | 51 | 52 | 49 | 49 | 81 |
| | Ma/Mb | 0.95 | 0.96 | 0.98 | 0.90 | 0.92 | 0.84 | 0.84 | 0.78 |
| Noise (dB) | | −3.6 | −3.3 | −4.1 | −2.7 | −2.8 | −2.7 | −2.2 | +0.2 |
| Magnetic tape | | T-9 | T-10 | T-11 | T-12 | T-13 | T-14 | T-15 | T-16 |
| Magnetic | Type | C-7 | C-1 | C-4 | C-6 | C-7 | C-8 | C-3 | C-3 |
| coating | Magnetic powder | Iron | ← | Fe—Co | Iron | ← | Fe—Co | Iron | ← |
| composition | | nitride | | | nitride | | | nitride | |
| | Concentration (%) of first | 30 | 30 | 30 | 45 | 30 | 45 | 20 | 20 |
| | composition | | | | | | | | |
| | Concentration (%) of second | 70 | 90 | 90 | 90 | 70 | 90 | 95 | 95 |
| | composition | | | | | | | | |
| Drying | Constant-rate drying period | 0.1 | 0.1 | 0.1 | 5 | 5 | 0.1 | 5 | 0.1 |
| treatment | (sec.) | | | | | | | | |
| Orienting | First orientation (kA/m) | 558 | 399 | 399 | 558 | 558 | 558 | 399 | 160 |
| treatment | Second orientation (kA/m) | 239 | 399 | 399 | 239 | 239 | 239 | 399 | 558 |
| | Positions of first and second | Contin- | Contin- | Contin- | Contin- | Contin- | Contin- | Contin- | Contin- |
| | orienting magnets | uous | uous | uous | uous | uous | uous | uous | uous |
| | Fluctuation of second | 30 | 70 | 70 | 30 | 30 | 30 | 30 | 30 |
| | orientation magnetic field (%) | | | | | | | | |
| Autocovariance | Lengthwise direction Ma (nm) | 68 | 40 | 46 | 63 | 67 | 72 | 39 | 45 |
| length | Widthwise direction Mb (nm) | 82 | 65 | 69 | 68 | 71 | 89 | 38 | 37 |
| | Ma/Mb | 0.83 | 0.61 | 0.67 | 0.93 | 0.94 | 0.81 | 1.03 | 1.22 |

| | | | | | | | | |
|---|---|---|---|---|---|---|---|---|
| Noise (dB) | +0.4 | +0.1 | +0.2 | −2.0 | −2.0 | −0.1 | −4.0 | −0.1 |

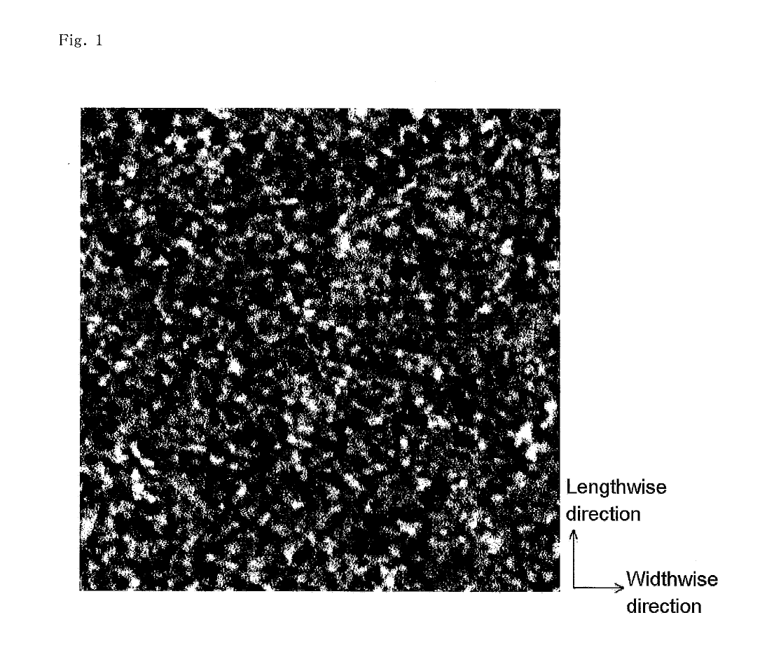

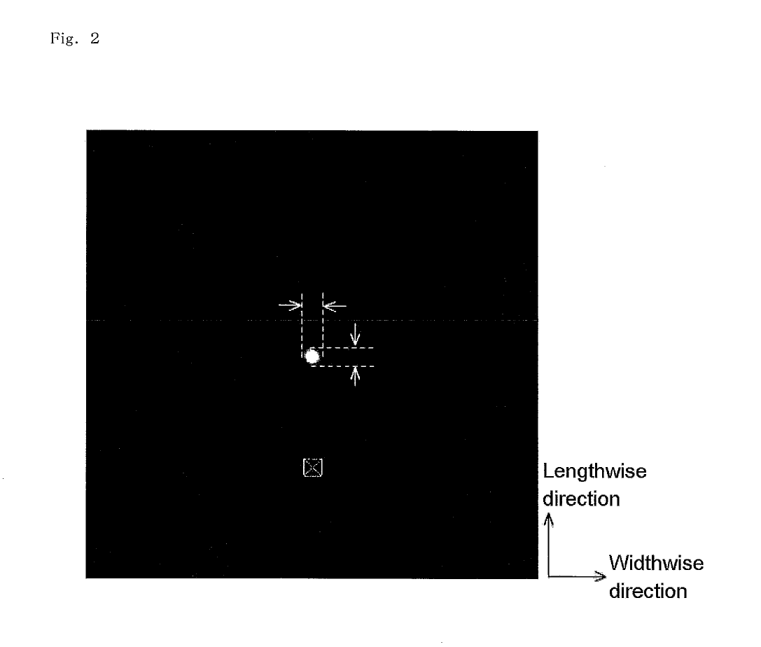

FIG. 1 shows the leakage magnetic field image of the magnetic layer of the magnetic tape (T-1), and FIG. 2 shows the magnetic correlation of the leakage magnetic field image shown in FIG. 1. The autocovariance length Ma of the magnetic tape (T-1) in the lengthwise direction is 42 nm, and the autocovariance length Mb thereof in the widthwise direction is 44 nm. Thus, the ratio of Ma to Mb (Ma/Mb) is 0.95. It can be found that the agglomeration of the magnetic particles in the magnetic layer of this magnetic tape is little both in the lengthwise direction and in the widthwise direction, and it can also be found that the agglomeration of the magnetic particles is isotropic. Comparing the magnetic tapes each comprising the same magnetic particles, it is seen that a magnetic tape of which the autocovariance lengths both in the lengthwise direction and in the widthwise direction are smaller and in which the agglomeration of the magnetic particles is isotropic is more effectively reduced in medium noise. As can be seen from Table 8, some of the magnetic tapes, of which the autocovariance lengths both in the lengthwise direction and in the widthwise direction are smaller and the ratio Ma/Mb is smaller, can be more effectively reduced in medium noise in high density recording, than the conventional high density recording magnetic tapes. On the other hand, it is seen that the magnetic tape of which the autocovariance length in either one of the lengthwise direction and the widthwise direction is large, and the magnetic tape in which the agglomeration of the magnetic particles is unevenly formed in the lengthwise or widthwise direction, in spite of its small autocovariance lengths, are poor in noise-reducing effect.

What is claimed is:

1. A magnetic recording medium which comprises a non-magnetic substrate and a magnetic layer formed on the non-magnetic substrate, wherein the magnetic layer contains magnetic powder with a particle size of 40 nm or less and a binder, an autocovariance length Ma of the magnetic layer in its lengthwise direction is 70 nm or less, and an autocovariance length Mb of the magnetic layer in its widthwise direction is 80 nm or less, and a ratio of the autocovariance length Ma to the autocovariance length Mb (Ma/Mb) is from 0.80 to 1.20.

2. The magnetic recording medium of claim 1, wherein said magnetic layer contains iron nitride magnetic particles as the magnetic particles.
